(19) United States
(12) Patent Application Publication
(10) Pub. No.: US 2016/0232144 A1
(43) Pub. Date: Aug. 11, 2016

(54) BROWSER EXTENSION ALLOWING WEB USERS TO DRAW ON LIVE WEB PAGES

(71) Applicant: Liang Zhou, White Plains, NY (US)

(72) Inventor: Liang Zhou, White Plains, NY (US)

(21) Appl. No.: 14/616,003

(22) Filed: Feb. 6, 2015

(51) Int. Cl. G06F 17/24; G06F 17/22; G06T 11/20; H04L 29/08

(52) U.S. Cl. CPC G06F 17/241; H04L 67/025; G06F 17/2247; G06T 11/203; G06F 17/242

(57) ABSTRACT

A web browser extension for annotating live web pages. Upon being installed on a web browser and launched, the browser extension inserts a content script into the underlying web page, that creates a floating and draggable control panel of drawing tools and a transparent canvas to overlay a live web page on which user can draw or text. Also provided are tools for taking screenshot of the visible part of the overlaid web page and create image for downloading or printing.

### DESCRIPTION OF RELATED ART

The present application relates to a web browser extension, and more particularly to a web browser extension that allows a web user to draw or make marks on a live web page and make comments.

Note that the points discussed below may reflect the hindsight gained from the disclosed inventions, and are not necessarily admitted to be prior art.

Currently web browsers only display web contents provided from a web source, it is cumbersome to annotate a web page and share this annotation with colleagues and friends. Yet no browser function is available that enables web users to draw or make marks directly on the web screen that they are visiting.

Web users can be found frustrated when they want to quickly add some graphics or annotations to share with other people.

There is a need for such web browser extension utility to easily add-on to the currently available web browsers to render a web page annotatable.

### SUMMARY

The present application discloses a web browser extension that can be easily added on to a web browser to allow users the ability to make instant notes and annotations on live web pages.

In one aspect of an embodiment, an extension is provided that inserts a content script to client web browser wherein the content script initializes a group of functions for drawings.

In another aspect of an embodiment, a group of functions that are initialized include a group of event handlers for creating a control panel and for creating a transparent canvas.

In another aspects of an embodiment, a transparent canvas is provided by calling for HTML5 transparent canvas element to overlay a live webpage wherein the canvas listens to mouse and touch events commands to render drawing and texting.

In another aspects of an embodiment, a control panel is provided by enabling a group of drawing tools that execute user commands for mouse and touch events, such as shape drawings, color selections, line selections and erasing, etc.

In another aspects of an embodiment, the content script communicates with the extension which use browsers provided API to take screenshot of visible part of annotated web page and create downloadable and printable image. Users can get these benefits by installing the extension to their browsers.

The disclosed innovation, in various embodiments, provide one or more of at least the following advantages: that users are enabled to instantly comment or annotate any web pages that they are visiting, and they are enabled to make a record and share the annotation by taking a screenshot of the annotated webpage. However, not all of these advantages result from every one of the innovations disclosed, and this list of advantages does not limit the various claimed inventions.

### BRIEF DESCRIPTION OF THE DRAWINGS

The disclosed application will be described with reference to the accompanying drawings, which show important sample embodiments of the invention and which are incorporated in the specification hereof by reference, wherein:

FIG. 1 shows an example web annotation using a web browser extension to CHROME browser in accordance with this application.

FIG. 2 shows an example web annotation using a web browser extension to FIREFOX browser in accordance with this application.

FIG. 3 shows an example web browser extension initialization process in accordance with this application.

FIG. 4 shows an example web browser extension for creating a transparent canvas in accordance with this application.

FIG. 5 shows an example web browser extension for creating a draggable control panel in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The present invention may be described herein in terms of functional block components and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

It should be appreciated that the particular implementations shown and described herein are illustrative of the invention and its best mode and are not intended to otherwise limit the scope of the present invention in any way. Furthermore, the connecting lines shown in the various figures contained herein are intended to represent exemplary functional relationships and/or physical couplings between the various elements. It should be noted that many alternative or additional functional relationships or physical connections may be present in a practical incentive system implemented in accordance with the invention.

As will be appreciated by one of ordinary skill in the art, the present invention may be embodied as a method, a computation processing system, a device for computation processing, and/or a computer program product. Accordingly, aspects of the present invention may take the form of an entirely software embodiment an entirely hardware embodiment, or combining aspects of both software and hardware embodiment. Furthermore, the present invention may take the form of a computer program product on a computer-readable storage medium having computer-readable program-code means embodied in the storage medium. Any suitable computer-readable storage medium may be utilized, including hard disks, CD-ROM, optical storage devices, magnetic storage devices, and/or the like.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

API is the abbreviation of application program interface, is a set of routines, protocols, and tools for building software applications. API specifies how software components should interact.

A web browser herein is a software application for retrieving, presenting and traversing information resources (content) on the World Wide Web. An information resource is identified by a Uniform Resource Identifier (URI/URL) and may be a web page of text, image, video or other piece of content. These content are generally presented within a web browser screen.

Web browser functionality includes user interface, layout engine, rendering engine, JavaScript interpreter, UI backend, networking component and data persistence component. These components achieve different functionalities of a web browser and together provide all capabilities of a web browser. Various web markup protocols have been developed to display various web content.

In the case of http, https, file, and others, once the resource has been retrieved the web browser will display it. HTML and associated content (image files, formatting information such as CSS, etc.) is passed to the browser's layout engine to be transformed from markup to an interactive document, a process known as “rendering”. Aside from HTML, web browsers can generally display any kind of content that can be part of a web page. Most browsers can display images, audio, video, and XML files, and often have plug-ins to support Flash applications and Java applets and Javascripts. Upon encountering a file of an unsupported type or a file that is set up to be downloaded rather than displayed, the browser prompts the user to save the file to disk. The major web browsers include Firefox, Internet Explorer, Google Chrome, Opera, and Safari.

A browser extension is a computer program that extends the functionality of a web browser.

It is contemplated and intended that the design and method described herein be applied to any web browsers that provides a group of APIs for extensions and add-ons; for clarity reason, the examples are given based on GOOGLE CHROME web browsers, but an ordinary person in the art would know the variations to modify the design to make it suitable to other web browsers.

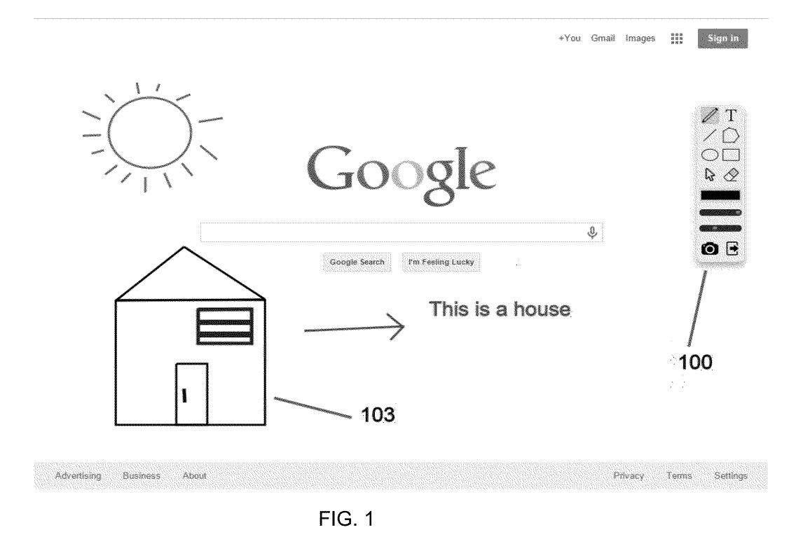

FIG. 1 shows an example annotated live web page that a user is viewing. Numeral 100 refers to a control panel that includes a set of drawing tools, and on the transparent canvas 105 that overlays the GOOGLE search web page, a user can draw or text, for example a house and a sun 103, the end effect is an annotated GOOGLE search web page. A user can then take a screen shot to record this annotation.

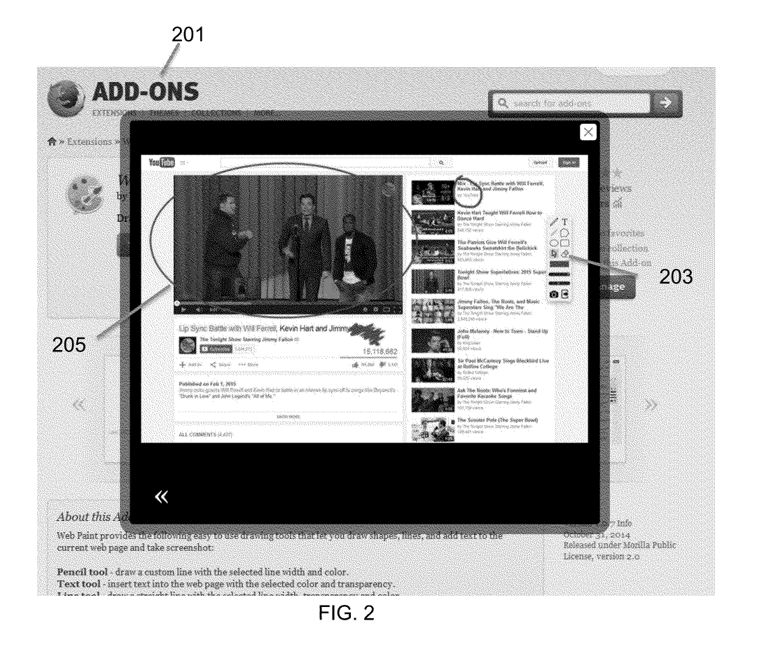

FIG. 2 shows an example annotation over a video clip of youtube.com web page that a user is viewing using FIREFOX web browser. Numeral 203 refers to a control panel that includes a set of drawing tools, and on the transparent canvas 205 that overlays youtube.com video window, a user can draw or text, for example a circle. The end effect is an annotated image from a youtube.com. A user can then take a screen shot to record this annotation.

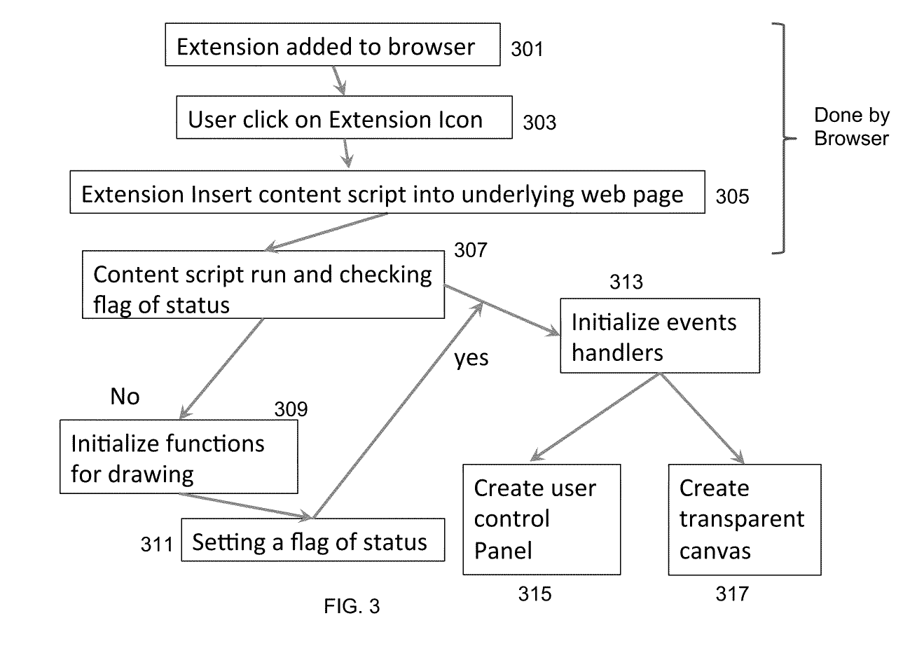

FIG. 3 shows an exemplary functional process of a web browser extension of this invention. Web browser will perform the steps from 301 to 305 while the browser extension script will perform the steps from 307 to 317. A user downloads and adds the browser extension to a web browser at step 301, he then triggers the browser extension icon at step 303 to start a content script in the browser extension which renders at step 305 the web browser to insert the content script from the browser extension into the web browser.

The content script is a script that runs on the underlying web page. Upon insertion is done, the content script will run automatically. First thing to do is checking if it has been already inserted before at step 307. If no, at step 309, the content script will initialize, including initializing variables and setting up a flag at step 311 to indicate that the content script has been inserted and executed.

If yes, which means the content script has already been executed by the current web page. It will go ahead at step 313 and create a control panel at step 317 and a transparent canvas overlay in the underlying web page at step 315. Users can operate on the control panel and draw or text on the transparent canvas overlay with mouse or touch screen.

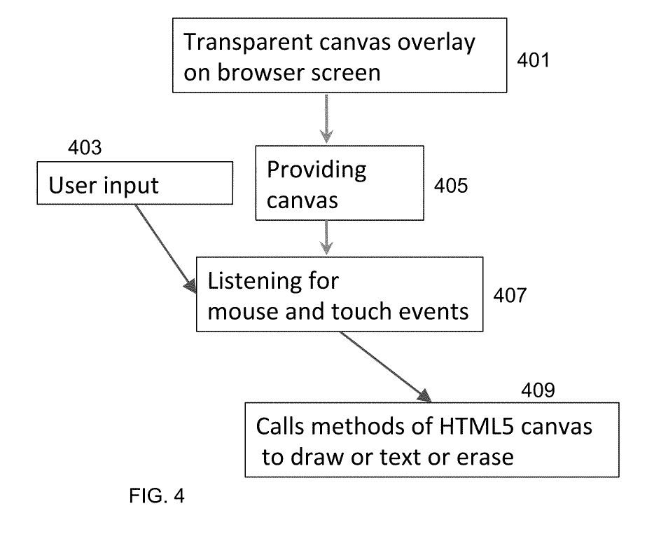

FIG. 4 shows an exemplary functional process of a transparent canvas overlay. The transparent canvas overlay may be implemented through using an HTML5 canvas element at step 401 with transparent background, which automatically resize itself at step 405 to fit the browser screen upon user resize the browser in order to cover the whole web page.

With user input at step 403, the transparent canvas overlay will listen for the mouse and touch events at step 407. With the command sent from the control panel, it enables users to draw and text on it at step 409. Depending on the drawing commands selected from the control panel, users can draw shapes (polygon, circle, ellipse, rectangle), lines, add text with the selected color, transparency and line width, and erase parts of the drawings.

The transparent canvas overlay can set CSS3 property pointer-events to “none” to ignore all the mouse/touch events and relay those events to the underlying web page, so that users can interact with the web page without removing the canvas overlay.

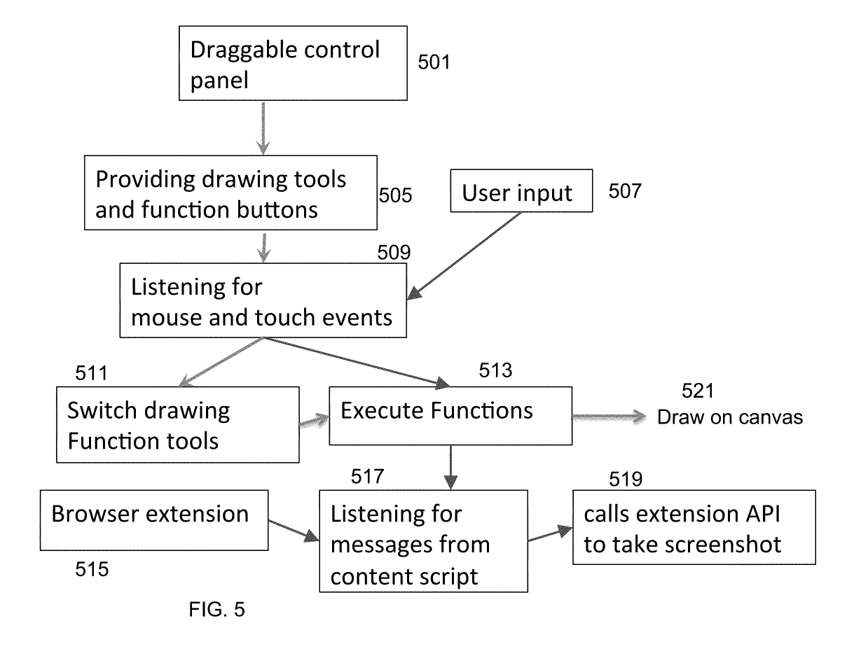

In reference to FIG. 5, it shows an exemplary functional process of a control panel. The control panel provides a group of functions at step 505, which listen for the mouse and touch events at step 509. Through user input actions 507, a user can select a drawing tool, color, transparency, line width, and eraser, or issue a command to take a screenshot of the visible part of the web page with the drawings, interact with the web page or exit the drawing function. The panel can be dragged to prevent it from constantly covering some content of underlying web page.

A user can switch and select drawing tools at step 511, and execute a drawing function at step 513 and draw on the transparent canvas at step 521. The user can also send a command at 513 though control panel to the content script, which calls the browser extension API at step 519 to take a screenshot of the visible area of the web page. The content script relay this command to the extension, which take a screenshot with the browser provided API and open a new tab with the image data where the screenshot will be presented. On the new tab, users are able to download the image or print it.

Users can send a command though control panel to the content script to exit the drawing function, which will remove the control panel and the transparent canvas overlay and clear all the data and events handlers that are bonded with drawings so that it won't affect the browser speed while drawing function is not needed. Users can trigger the browser extension icon again to initiate the process illustrated in FIG. 3.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A method for annotating a live web page, comprising the steps of:
installing a web browser extension having a content script on a web browser;
navigating to a live web page on a computer with said web browser;
said browser extension inserting the content script into said web browser;
said content script initializing said web browser extension and providing a floating and draggable control panel of drawing tools and a transparent canvas overlaying said live web page;
activating a drawing tool and drawing a shape or a text with mouse or keyboard on said transparent canvas, whereby the live web page can be viewed as a marked live web page by the drawing tool; and
said web browser extension listening to a message sent from said content script for taking a screenshot and creating viewable image of the marked live web page.

2. The method for annotating a live web page of claim 1, wherein said transparent canvas automatically resize itself to always cover the entire live web page when the live web page changes its size.

3. The method for annotating a live web page of claim 1, wherein said transparent canvas is configured to set CSS3 property pointer-events to “NONE” to ignore all the mouse/touch events and relay mouse/touch events to the live web page when a user needs to interact with the content of the web page.

4. The method for annotating a live web page of claim 1, wherein said draggable control panel contains a set of drawing tools for drawing shapes of polygon, circle, ellipse, rectangle, lines, text, selecting color, transparency, line width, and erasing a drawings.

5. A web browser extension for annotating a live web page, comprising:
an extension icon for user interaction;
a content script;
an extension background script that listens for messages from the content script and said extension icon, wherein said content script is inserted by said background script into the live web page;
a floating and draggable control panel of drawing tools that is created by said content script;
a transparent canvas that is created by said content script overlaying said live web page to form an overlaid web page;
wherein said background script is configured to utilize web browser API to take a screenshot of the overlaid web page, and to create a viewable, downloadable and printable image from raw image data generated by web browser API.

6. The web browser extension of claim 5, wherein said transparent canvas automatically resize itself to always cover the entire web page when the live web page changes its size.

7. The web browser extension of claim 5, wherein said transparent canvas is configured to set CSS3 property pointer-events to “none” to ignore all mouse/touch events and relay a mouse/touch event to the web page when user needs to interact with the web page.

8. The web browser extension of claim 5, wherein said draggable control panel contains a set of drawing tools for drawing shapes of polygon, circle, ellipse, rectangle, lines, text, selecting color, transparency, line width, and erasing a drawings.
